(19) United States
(12) Patent Application Publication
(10) Pub. No.: US 2025/0392665 A1
(43) Pub. Date: Dec. 25, 2025

(54) METHODS AND SYSTEMS FOR PROGRAMMABLE NETWORK API MONETIZATION

(71) Applicant: T-Mobile USA, Inc., Bellevue, WA (US)

(72) Inventor: Murugappan Palaniappan, Issaquah, WA (US)

(21) Appl. No.: 18/750,676

(22) Filed: Jun. 21, 2024

(51) Int. Cl. H04M 15/00

(52) U.S. Cl. CPC H04M 15/60; H04M 15/48

(57) ABSTRACT

Methods and systems for programmable network API monetization are described herein. A network-as-a-service (NaaS) function may receive, from the application running on a computing device associated with a customer of a wireless service provider, a request for a network resource, the request including an application ID, a device ID, and a time period for using the network resource. The NaaS may authenticate the application ID and the device ID. Upon authenticating the application ID and the device ID being successful, the NaaS may grant the network resource to the application for the time period. Further, the NaaS may generate, based on granting the network resource to the application for the time period, charging data directed to the customer. In implementations, the NaaS may generate the charging data based at least in part on a number of API calls from the application.

### BACKGROUND

The wireless communication technology begins to power everything from connected farms to connected cars. Wireless service providers such as T-Mobile, is fueling innovation and building the fifth generation (5G) ecosystem with a number of initiatives. Halo, an on-demand, driverless car service in the U.S. is an example of initiative built on the T-Mobile 5G ecosystem. With Halo, visitors or residents can quickly summon a sleek, driverless all-electric Halo with the push of a button. A driverless Halo then arrives at the pick-up location and drives the visitors or residents to their destination.

Software/mobile App developers have built various types of quality on demand (QoD) applications through the T-Mobile 5G ecosystem. The QoD application, when activated, calls an application programmable interface (API) to connect to pre-configured network resource (e.g., network slice) of the 5G network. Each QoD application is given a unique application context identifier (ACID), which is made available to the customers on the billing systems. The QoD applications may be embedded in the computing systems of the driverless cars. In real-time circumstances, the default network slices may not be sufficient to support the QoD application. The computing system of the driverless car may automatically initiate a request to upgrade to a QoD profile mapped to a network slice with better response time and throughput and send the request to the wireless service provider partnered with the driverless car business (e.g., car rental companies, delivery companies, etc.). However, as the billing is performed on the customers (e.g., the driverless car business) on the corresponding billing systems in a secure and authorized manner, a response to the request from the wireless service provider (e.g., T-Mobile) granting additional network resources may be delayed, causing poor customer experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment, in which techniques for programmable network API monetization are implemented, according to an implementation of the present disclosure.

FIG. 2 illustrates an example diagram, in which techniques for programmable network API monetization are implemented, according to an implementation of the present disclosure.

FIG. 3 illustrates an example scenario, in which techniques for programmable network API monetization are implemented, according to an implementation of the present disclosure.

FIG. 4 illustrates an example scenario, in which techniques for programmable network API monetization are implemented, according to another implementation of the present disclosure.

FIG. 5 illustrates an example for programmable network API monetization, according to an implementation of the present disclosure.

FIG. 6 illustrates an example computing device that implements techniques for programmable network API monetization, according to the present disclosure.

### DETAILED DESCRIPTION

Techniques for programmable network application programming interface (API) monetization are disclosed herein.

According to an aspect of the present disclosure, a computing device may detect an activation of an application running on a computing device associated with a customer partnering with a wireless service provider. The customer may include enterprise customers that provide services to the clients based on the wireless network resources. The customer may subscribe to one or more network resources of the wireless service provider. The computing device may further receive, from the application, a request for a network resource, the request including an application identifier (ID), a device ID, and a time period for using the network resource following the activation of the application. The computing device may authenticate the application ID and the device ID and determine whether the application ID and the device ID are authorized to use the subscribed network resources. Upon authenticating the application ID and the device ID being successful, the computing device may grant the network resource to the application for the time period, and generate charging data directed to the customer.

In some examples, the application may include a quality on demand (QoD) application developed through an API platform provided by the wireless service provider. The QoD application may be assigned with a unique application ID, e.g., an application context identifier (ACID), which is further stored in a billing system of the wireless service provider. In some examples, the network resource includes a network slice allocated to the application with a quality of service (QoS) profile.

In implementations, the request may further include a quality of service (QoS) profile corresponding to the QoD application, and the computing device may further validate that the QoS profile is included in services subscribed by the customer. When the QoS profile is included in services subscribed by the customer, the computing device may generate a Service Order Code (SOC) feature corresponding to the QoS profile, and provision the network slice to be assigned to the QoD application. The SOC feature may indicate a type of slice to be assigned to the QoD application and is associated with a slice ID.

In some examples, the computing device may build a data storage associated with a plurality of customers partnering with the wireless service provider. The computing device may, for each customer of the plurality of customers, create a corresponding customer record including a corresponding device ID, a corresponding customer billing account number, a corresponding customer name, a corresponding application ID, and a corresponding charging channel. The device ID may uniquely identify a computing device, on which, the application operates. For example, the device ID may include a Mobile Station International Subscriber Directory Number (MSISDN). In some examples, the computing device may receive an authorized range of MSISDN from each customer. In some example, each application ID may correspond to a customer billing account number. In some examples, each customer may be assigned with a charging channel in the billing system of the wireless service provider, through which, an invoice to the customer may be sent.

In implementations, the computing device may search the data storage for a match between the application ID and the device ID and data of a customer record in the customer records. Based on the match between the application ID and the device ID with the data in a customer record of the customer records being present, the computing device may determine that the application ID and the device ID are authenticated.

In some examples, the computing device may immediately send the charging data for a time period to the billing system once the network slice provisioning is completed. In some examples, the computing device may receive, from the application, a second request to remove the network resource. The computing device may determine that a duration of using the network slice is less the time period and issue a refund corresponding to remaining duration to the customer.

In implementations, the computing device may count the units consumed by the application during the QoD session (e.g., a number of API calls from the application) and generate the charging data based on the number of API calls from the application. In implementations, the computing device may include one or more network elements/functions of the wireless service provider such as a NaaS function, a QoD service function, a charging function, a Multi-Mediation (EMM) platform, etc.

According to the present disclosure, the data storage may be connected to the computing device locally and/or via a network, facilitating an effective authorize of the application on the customer’s devices, additional network resource, and/or an upgrade of the pre-purchased network resource. Further, by counting the number of API calls from the application, the present disclosure may facilitate the computing device to streamline the billing to the main billing system on the wireless service provider.

The techniques discussed herein may be implemented in a computer network using one or more of protocols including but are not limited to Ethernet, third generation (3G), fourth generation (4G), Long-Term Evolution (LTE), fifth generation (5G), sixth generation (6G), the further radio access technologies, or any combination thereof. In some examples, the network implementations may support standalone architectures, non-standalone architectures, dual connectivity, carrier aggregation, etc. Example implementations are provided below with reference to the following figures.

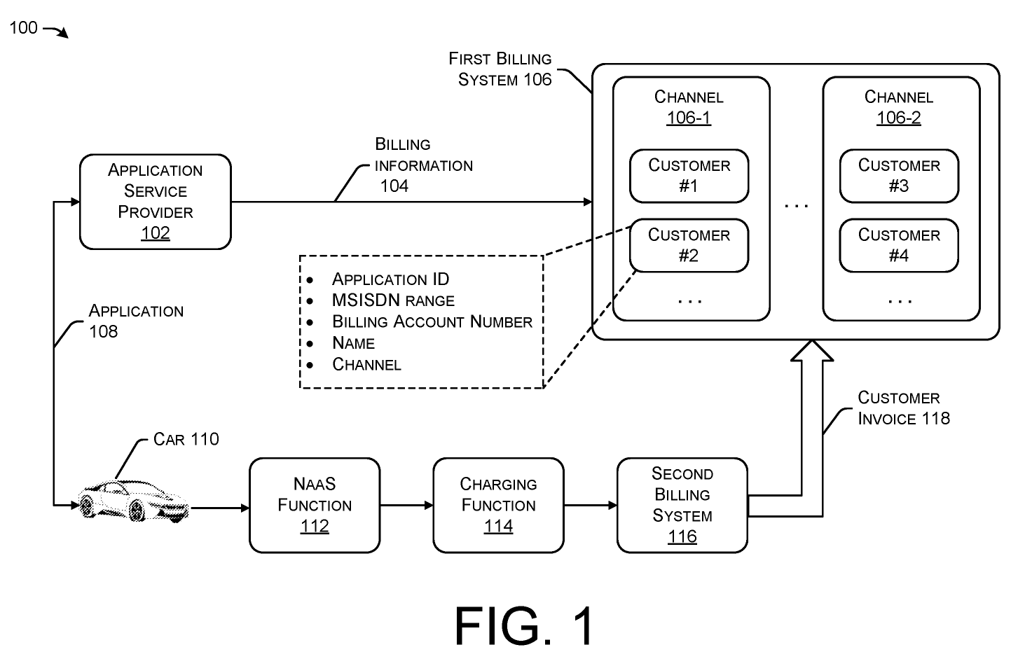

FIG. 1 illustrates an example environment, in which techniques for programmable network API monetization are implemented, according to an implementation of the present disclosure.

Customers may partner with a wireless service provider to develop business based on the network infrastructure of the wireless service provider. For example, a car rental company may subscribe to the services of the wireless service provider in order to provide the voice and broadband data service to the customers. Alternatively and/or additionally, business using autonomous vehicles may subscribe to the services of the wireless service provider to provide auto-navigation to the customers. In another examples, a computer gaming place may provide augmented reality (AR) experience based on the 5G services of the wireless service provider. In yet another example, business that relies on drones for videography, delivery, search and rescue, agriculture, and/or transportation may also subscribe to the wireless services.

As shown in the example environment 100, a rental car company (e.g., Avis, Hertz, etc.) may install an application 108 on a computing system of a car 110. The application 108 may be developed by an application service provider 102 based at least partly on an API of a computer system provided by the wireless service provider. The application 108 may be a computer program written in any suitable programmable language. In some examples, the rental car company may install multiple applications on the computing system of the car 110. In some examples, the car rental company may additionally provide one or more portable electronic devices in the car 110. The application service provider 102 may provide the application 108 to be compatible with the one or more portable electronic devices.

In some examples, the application 108 may be developed using a quality on demand (QoD) API of the computer system provided by the wireless service provider. The QoD API allows the application developer to request that a specific network profile be applied to the device using a quality of service (QoS) parameter. Once activated on the device (e.g., the car 110), the application 108 developed using the QoD API (hereinafter referred to “QoD application”) may request an improved network connection such as bandwidth, latency, etc. The customer (e.g., the rental car company) may subscribe to or pre-purchase the network resources such as network slices to be assigned to the application 108 running on the device (e.g. the car 110). For example, the rental car company may subscribe to a slice for a video meeting application, a slice for remote vehicle maneuvering application, etc.

In implementations, the wireless service provider may create a profile for each customer in a billing system, e.g., a first billing system 106. As discussed herein, the application service provider 102 develops a variety of computer applications and/or mobile apps to be implemented on the customer’s properties (e.g., rental cars, AR devices, etc.). These computer applications and/or mobile Apps are developed based at least partly on an API of a computer system provided through the wireless service provider. Any usage of computer applications and/or mobile Apps from on the customer’s properties (e.g., rental cars, AR devices, etc.) may trigger a charging data record (CDR) toward the customer’s profile in the first billing system 106. The application service provider 102 may send billing information 104 to the first billing system 106. As discussed herein, the billing information 104 may identify the application used in the customer’s properties such as an application ID, an application context identifier (ACID), etc. The billing information 104 may further identify the identities of the subscribers authorized to use the services provided by the wireless service provider such as a range of Mobile Station International Subscriber Directory Number (MSISDN) assigned to the customer. In some examples, the billing information 104 may further identify a name of the customer, a billing account number of the customer, a channel in the billing system 106 through which, the billing data will be sent. As shown in FIG. 1, customer #1 and customer #2 are billed through channel 106-1 in the first billing system 106; and customer #3 and customer #4 are billed through channel 106-2 in the first billing system 106.

In implementations, when the application 108 is activated in the car 110, triggering a request to use the pre-subscribed network resource to be sent to a Network-as-a-Service (NaaS) function 112. The application 108 implemented by the car 110 may communicate with an application server of the application service provider 102 to load necessary parameters and/or configurations to launch the application in the computing system of the car. The request from the application 108 may include an application ID, a MSISDN assigned to the car 110, etc. The NaaS function 112 may verify whether the application ID and the MSISDN are authorized identities by searching a backend database (not shown). Once the application ID and the MSISDN are verified, the NaaS function 112 may send a response authorizing the use of the application 108 in the car 110. Further, when the application 108 is used in the car 110, triggering data usage, the data traffic may be transmitted, via a wireless transceiver on the car 110, to a Network-as-a-Service (NaaS) function 112. Based on the data traffic, the NaaS function 112 may send a charging event message to a charging function 114. The charging function 114 may further generate a charging data record (CDR) corresponding the usage data, and send the CDR to a second billing system 116. Upon receiving the CDR, the second billing system 116 may send a customer invoice 118 to bill the customer through the corresponding channel in the first billing system 106. In some examples, the second billing system 116 may perform formatting of the CDR in order to be suitable to generate the customer invoice 118. In some examples, the NaaS function 112, when reporting the application usage data to the charging function 114, may also include one or more parameters such as the customer’s billing account number, the customer’s name, and the channel to be billed, etc. The charging function 114 may further include the one or more parameters in the CDR to the second billing system 116. With the one or more parameters, the second billing system 116 may bill the customer’s billing account number with the customer’s name to the channel in the first billing system 106. In some examples, the charging function 114 may also count on the units consumed by the application 108 (e.g., the number of API calls from the application) and generate a metered CDR to the second billing system 116.

The NaaS function 112, the charging function 114, and the second billing system 116 may be implemented by the wireless service provider to bridge the charging events triggered on the customer’s property (e.g., the car 110) with the billing system 106 of the wireless service provider (e.g., the first billing system 106). In some examples, the second billing system 116 may be implemented by an Multi-Mediation (EMM) platform of the wireless service provider. In yet other examples, the second billing system 116 may be implemented by the EMM platform and an API platform (e.g., DevEdge platform of T-Mobile)open to the application service provider 102.

It should be appreciated that the elements/functions shown in the example environment 100 are for the purpose of illustration. The present disclosure is not intended to be limiting. The application 108 implemented on the car 110 may include a variety of computer applications and/or mobile Apps including but not limited to navigation application, video conference application, video streaming application, gaming application, etc. The customer (e.g., rental car company) may pre-purchase network resources from the wireless service provider to support the use of the variety of computer applications and/or mobile apps in the associated devices (e.g., rental cars). The pre-purchase network resources may include network slices to be assigned to the navigation application, video conference application, video streaming application, gaming application, etc. The customers that use the application 108 developed by the application service provider are not limited to car rental companies. The customers may include any businesses that provide to their customers with quality on demand services through the wireless service provider such as the business that relies on drones for videography and delivery, the business that uses autonomous cars for public transportation, etc.

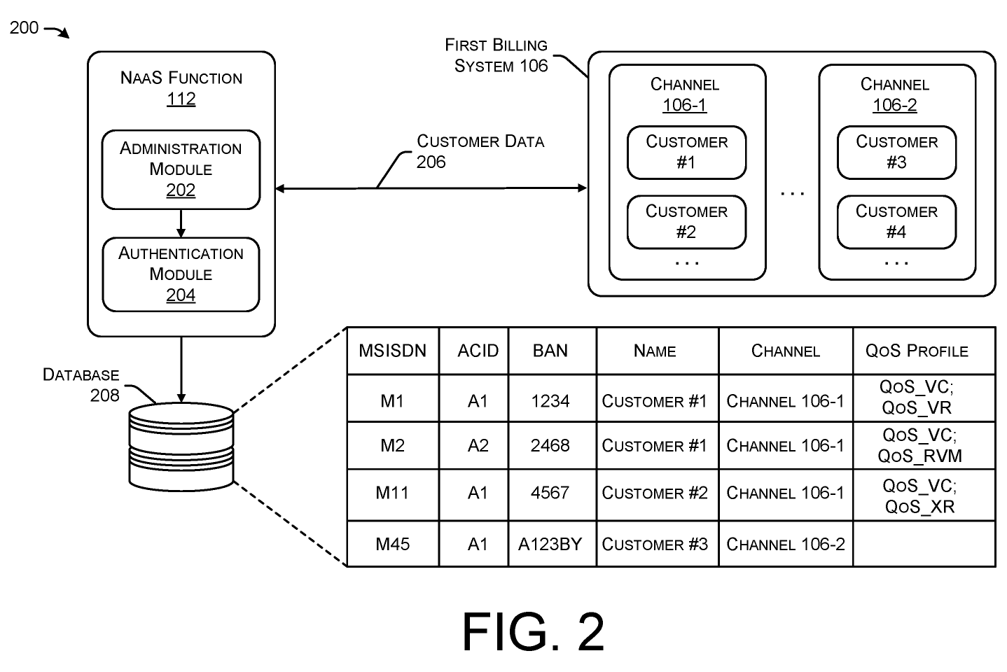

FIG. 2 illustrates an example diagram, in which techniques for programmable network API monetization are implemented, according to an implementation of the present disclosure.

According to the example diagram 200, the NaaS function 112 may communicate with a backend database, e.g., database 208, for authentication and billing purposes. The database 208 may be separate from the first billing system 106 and store the data related to billing the customers, e.g., business customers. For example, the database 208 may store a range of MSISDN assigned to a customer, an application ID (e.g., ACID) corresponding to an application implemented in the customer’s properties, one or more billing account numbers (BANs) of the customer, a name of the customer, a channel to be billed in the first billing system 106, one or more quality of service (QoS) profiles associated with the customer, etc. In some examples, each MSISDN may be associated with an individual application ID, an individual billing account number, and one or more QoS profiles. For instance, MSISDN M1 of Customer #1 is associated with ACID number A1, BAN 1234, and two QoS profiles, QoS_VC and QoS_VR.

In some examples, the NaaS function 112 may include an administration module 202 and an authentication module 204. The administration module 202 may communicate with the first billing system 106 to obtain customer data 206 related to billing, e.g., business customers, from the first billing system 106. The customer data 206 may be further stored in the database 208 associated with the second billing system 116. When an application (e.g., application 108 of FIG. 1) is activated in the customer’s property (e.g., car 110 of FIG. 1), a request to use the service subscribed to the wireless service provider may be triggered. The request may include an application ID (e.g., A1) and a customer name associated with the computing device of the customer’s property (e.g., Customer #1). The authentication module 204 of the second billing system 116 may search the database 208 and verify whether the application and the customer’s property are authorized to use the subscribed service. For example, the authentication module 204 may verify whether the application ID (e.g., A1) and Customer #1 are authorized to use the service. The authentication module 204 may further select an MSISDN from the pre-assigned MSISDNs associated with the customer to be used by the application. The authentication module 204 may further determine the QoS profile corresponding to the application ID for SOC provisioning. With the database 208 communicatively coupled to the second billing system 116, the second billing system 116 may effectively authorize an activation of the application on the customer’s properties, an additional network resource, and/or an upgrade of the pre-purchased network resource. The database 208 also facilitates the second billing system 116 to streamline the billing to the first billing system 106 on the wireless service provider.

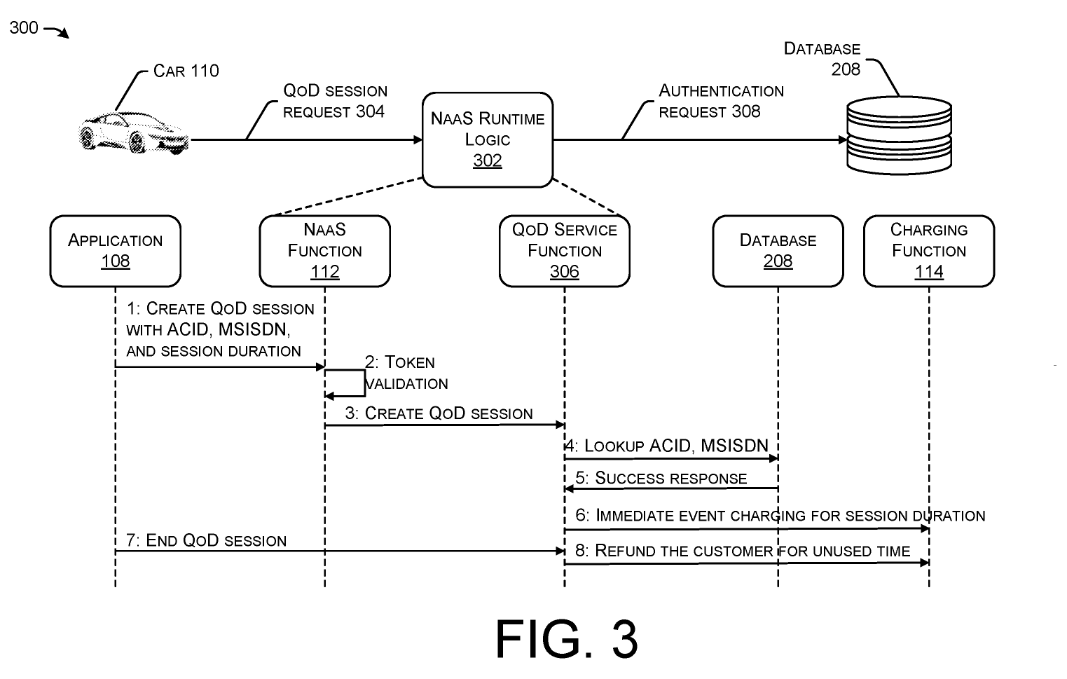

FIG. 3 illustrates an example scenario, in which techniques for programmable network API monetization are implemented, according to an implementation of the present disclosure.

The example scenario 300 illustrates authentication performed by a runtime logic of the NaaS function, e.g., NaaS runtime logic 302. The NaaS runtime logic 302 may be performed by the NaaS function 112 and a QoD service function 306. As illustrated, the car 110 may send a QoD session request 304 to create a QoD session toward the NaaS runtime logic 302. The QoD session request 304 may be automatically triggered when an application installed in the computing system of the car 110 is activated. For instance, when the computing system of the car 110 detects that a customer launches an embedded navigation app, the computing system of the car 110 may automatically send the QoD session request 304, requesting to use a pre-purchased network resource (e.g., a network slice pre-purchased to use the navigation app). In some examples, the QoD session request 304 may indicate an identity of the user, e.g., the subscriber of the service provided through the wireless service provider. In some examples, the identity of the user may include an application ID (e.g., ACID associated with the navigation app), a device ID (e.g., MSISDN assigned to the car 110), a session duration (e.g., a pre-set two-hour session) etc. In some examples, the QoD session request 304 may be automatically triggered when the application experiences high latency due to network congestion. In such circumstances, the QoD session request 304 may further indicate a session duration (e.g., two hours to use an additional network slice).

The NaaS function 112 may perform token validation on the QoD session request 304. Once the token is validated, the NaaS function 112 may send an authentication request 304 along with the request to create a QoD session to the QoD service function 306. The QoD service function 306 may look up the ACID and the MSISDN in the database 208 and verify whether the ACID and the MSISDN are authorized. If the ACID and the MSISDN are authorized, the QoD service function 306 may return a success response to the NaaS function 112. The NaaS function 112 may send an immediate event charging request for the session duration toward the charging function 114. In implementations, although not shown, the QoD service function 306 may continue with SOC provisioning logic on the corresponding channel. For instance, a QoD session API (not shown) may add SOC feature to the corresponding channel in the first billing system 106. The QoD session API may further provision a user data management (UDM) for the network slice granted to the QoD session.

As discussed herein, the user of the application may be granted with a pre-set session duration (e.g., two hours). In some circumstances, the user may end the QoD session before the granted session duration. The application operating on the car 110 may automatically send a request to end the QoD session. The NaaS runtime logic 302 may calculate the remaining duration and trigger a refund request to refund the customer for unused time to the charging function 114.

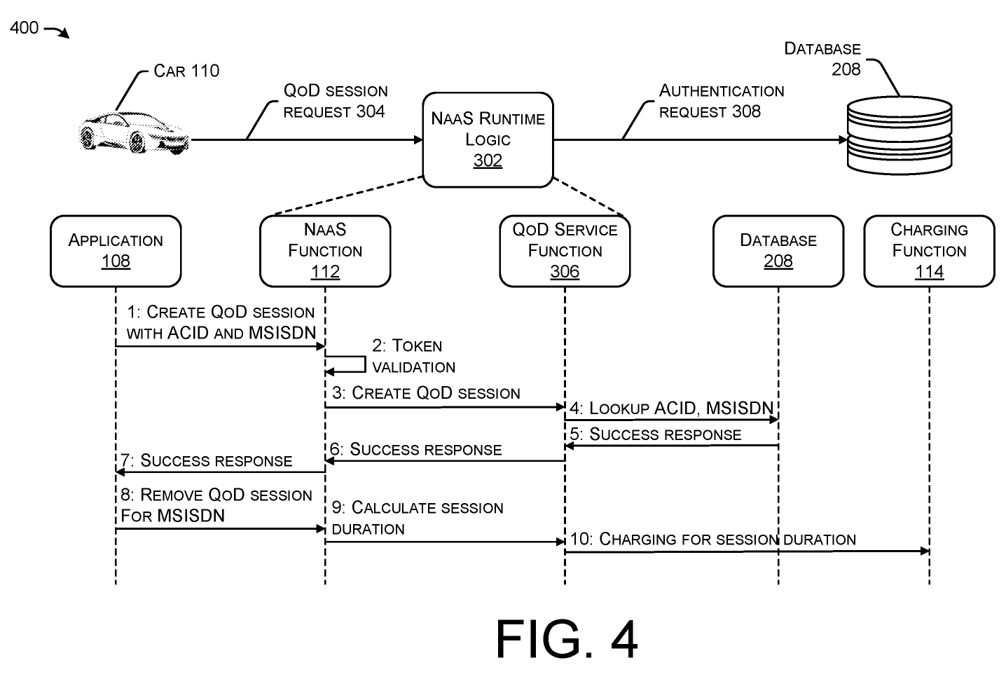

FIG. 4 illustrates an example scenario, in which techniques for programmable network API monetization are implemented, according to another implementation of the present disclosure.

The example scenario 400 illustrates authentication performed by the NaaS runtime logic 302 according to another implementation. According to the implementation, rather than indicating a session duration, the QoD session request 304 may only send the application ID (e.g., ACID) with the MSISDN to the NaaS function 112. Once the QoD session is successfully created, the NaaS function 112 may record this time as START TIME. Further, when a request to remove the QoD session from the MSISDN is received, the NaaS function 112 may record this time as STOP TIME and calculate the session duration. The NaaS function 112 may further forward the session duration to the QoD service function 306 to charge the subscriber for the session duration.

In implementations, one or more applications may run on the car 110. For instance, a rental car user may use the embedded navigation app and a video streaming app simultaneously. In such circumstances, one or more QoD sessions may be created for the apps used in the car 110. Each of the one or more QoD sessions may correspond to a QoS profile configured for the type of the QoD session. For instance, the navigation app may be assigned with a remote vehicle maneuvering slice with QoS_RVM profile. Meanwhile, the video streaming app may be assigned with a broadcast video streaming slice with QoS_BROADCAST profile. In implementations, when the latency experienced by the application exceeds a threshold, the application may automatically trigger a request for a new QoD session.

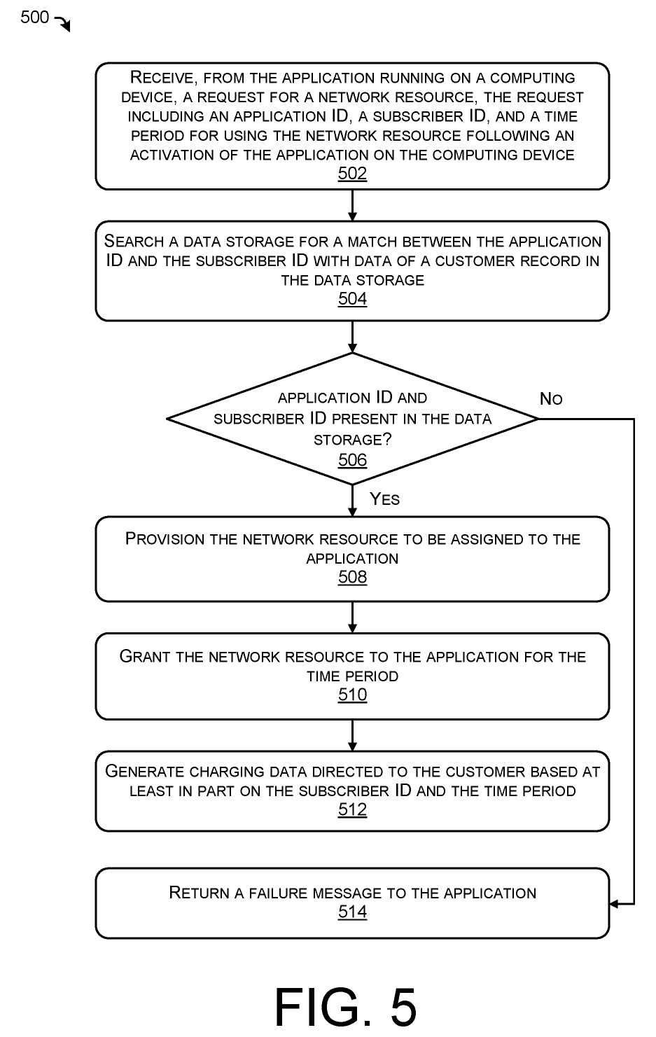

FIG. 5 illustrates an example process for programmable network API monetization, according to an implementation of the present disclosure. The example process 500 may be implemented by a NaaS runtime logic (e.g., the NaaS runtime logic 302) in a wireless communication network.

At operation 502, the process may include receiving, from an application running on a computing device, a request for a network resource, the request including an application ID, a subscriber ID, and a time period for using the network resource following an activation of the application on the computing device. The application on the computing device may be associated with a customer. In some examples, the computing device may be a standalone computing device such as a gaming device or a drone capable of connecting to a wireless network. In yet other examples, the computing device may be a computing system embedded in a property of the customer such as a computing system in a car of a rental company, a computing system in an autonomous vehicle of a public transportation company, etc. The application may include any computer applications or mobile apps that reply on the wireless network to provide services to the users. Examples of the application may include but are not limited to, a navigation application, a video broadcasting/streaming application, a video conferencing application, a videography application, etc.

As discussed herein, when built by the application service provider, each application may be assigned with a unique ID such as an application context identifier (ACID). The application ID, e.g., ACID, may be pre-stored in a billing system of a wireless service provider, e.g., the first billing system 106 of FIG. 1. The subscriber ID, for example, a Mobile Station International Subscriber Directory Number (MSISDN), may uniquely identify a subscription of the customer in the wireless network. A physical SIM card or a virtual SIM card may be associated with the computing device (e.g., the computing system of the car 110). In some examples, the request may also include a time duration to use the network resource following an activation of the application on the computing device, e.g., a network slice configured for the navigation application, the video streaming application, etc.

In some examples, the request may not specify a time duration to be used by the application. The NaaS function may calculate a session duration from a start time a QoD session is created and a stop time the QoD session is ended.

At operation 504, the process may include searching a data storage for a match between the application ID and the subscriber ID with data of a customer record in the data storage. As discussed herein, the data storage may be built aside from the billing system (e.g., the first billing system 106 of FIG. 1) of the wireless service provider. The data storage may store the information or customer records associated with generating the charging data triggered by the application. For each customer (e.g., the business customer such as Avis, Hertz, etc.), the customer records may include one or more application IDs that uniquely identify the applications running on the computing systems of the rental cars, a range of MSISDNs that uniquely identify the computing systems embedded on the rental cars, a name or description of the customer (e.g., Avis, Hertz, etc.), a billing account number of the customer, a channel corresponding to the customer in the billing system of the wireless service provider, one or more QoS profiles associated with network resources pre-configured for the applications running on the computing systems of the rental cars.

At operation 506, the process may include determining whether the application ID and the subscriber ID are present in the data storage. As discussed herein, the NaaS function may determine whether the application ID and the subscriber ID are authorized to use the network resource based on the customer records in the data storage. The application ID and the subscriber ID may be present in the data storage when the application ID and the subscriber ID match with data of a customer record in the customer records. When the application ID and the subscriber ID are not present in the data storage, the process may continue at operation 514, where the NaaS function returns a failure message to the application.

When the application ID and the subscriber ID are present in the data storage, at operation 508, the process may include provisioning the network resource to be assigned to the application. In implementations, the network resource may include a network slice with associated QoS profile to be used by the application. For instance, the customer (e.g., Avis) may pre-purchase a network slice with low latency QoS profile for a video streaming application installed on the rental cars. The network slice may be provisioned to related network elements and/or functions such as SIM card on the computing system of rental cars, radio resources on the access points, user data management (UDM) function for invoicing purpose, etc.

At operation 510, the process may include granting the network resource to the application for the time period. In implementations, once the request is authorized and the network resource is provisioned successfully, the network resource is granted to the application to use for the time period and a quality on demand (QoD) session is created between the computing system of the rental car and the network of the wireless service provider.

At operation 512, the process may include generating charging data directed to the customer based at least in part on the subscriber ID and the time period. As discussed herein, the request from the application indicates a time period for using the network resource. Once the QoD session is created, the NaaS function may generate a charging event toward a charging function (e.g., the charging function 114 in FIG. 1), causing the charging function to send charging data record (CDR) to the billing system. In some examples, upon the QoD session being successfully created, the NaaS runtime logic may immediately send a time duration along with the charging event to the charging function. In some examples, when the QoD session ends before the time duration, the NaaS runtime logic may calculate the remaining time duration and send the remaining time duration to the charging function to refund to the customer’s billing account. In some other examples, the NaaS runtime logic may calculate the time duration for the QoD session based on a start time and a stop time of the QoD session. In implementations, the NaaS function may count the units consumed by the QoD session (e.g., the number of API calls from the application) to generate metered charging data record to the billing system of the wireless service provider.

In implementations, when the computing device verifies whether the application ID and the subscriber ID are present in the data storage at operation 506, the computing device may obtain the customer data from the data storage. Based on the customer data, the computing device may retrieve the billing account number corresponding to the subscriber ID (i.e., the customer ID) and the channel number corresponding to the subscriber ID in the billing system associated with the wireless service provider (e.g., the first billing system 106). The computing device may then send the CDR and/or the refund of charging to the billing system using the billing account number and the channel number.

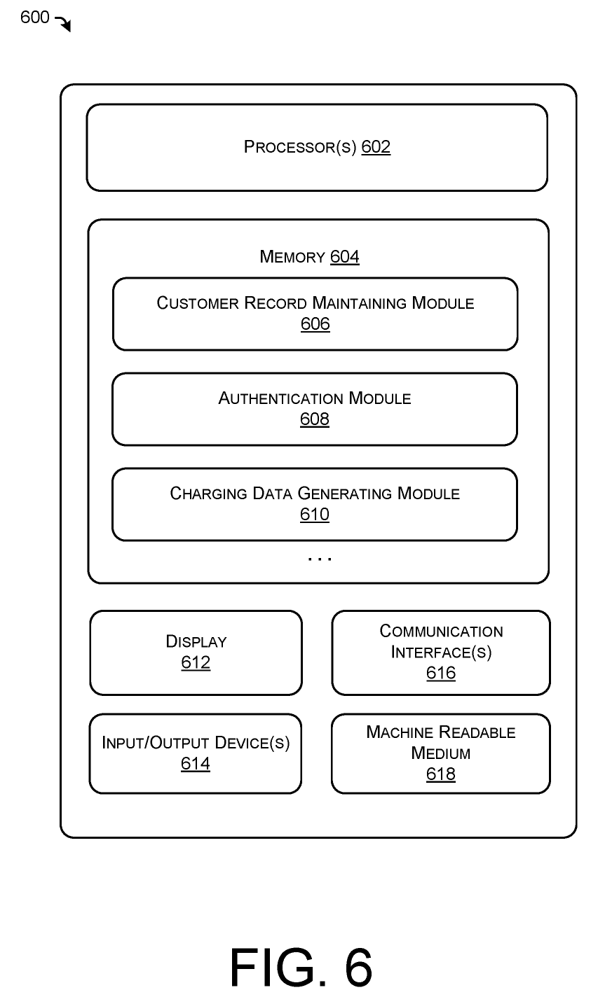

FIG. 6 illustrates an example computing device that implements techniques for programmable network API monetization, according to the present disclosure. The example computer device 600 may implement NaaS runtime logic (e.g., NaaS runtime logic 302 as illustrated in FIG. 3 and FIG. 4) to achieve the network API monetization in a wireless communication network.

In various examples, the processor(s) 602 can be a central processing unit (CPU), a graphics processing unit (GPU), or both CPU and GPU, or any other type of processing unit. Each of the one or more processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 602 may also be responsible for executing all computer applications stored in memory 604, which can be associated with common types of volatile (RAM) and/or nonvolatile (ROM) memory.

As illustrated in FIG. 6, the computing device 600 may comprise processor(s) 602, a memory 604 storing a customer record maintaining module 606, an authentication module 608, a charging data generating module 610, a display 612, input/output device(s) 614, communication interface(s) 616, and/or a machine readable medium 618.

In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 600. Any such non-transitory computer-readable media may be part of the computing device 600.

The customer record maintaining module 606 may be configured to maintain the customer record that facilitates charging of the customers for the usage of the network resource via applications implemented on the customer’s computing devices. As discussed herein, the customers may include business customers (e.g., enterprises) that rely on the wireless communication network to provide services. The enterprises may implement a variety of computer applications and/or mobile apps in the associated properties, e.g.,, buildings, cars, drones, gaming devices, etc. When a customer of an enterprise uses the application embedded in the associated properties, the usage data of the network resources may be automatically sent to a charging/billing function. The customer record maintaining module 606 may obtain customer information from the billing system of the wireless service provider and store the customer information in an associated database. The customer information may include but not limited to, the application ID that identifies the applications (e.g., ACID), the device ID that identifies the computing device on the wireless communication network (e.g., MSISDN), a billing account number of the customer, a name/description of the customer, a channel corresponding to the customer in the billing system of the wireless service provider, QoS profile associated with the application, etc. In some examples, the customer record maintaining module 606 may also add a new customer record to the associated database. In some other examples, the customer record maintaining module 606 may add a new ACID, a MSISDN to be associated with the new ACID, a QoS profile to be associated with the new ACID, to the associated database. In implementations, a range of MSISDN may be allocated to a customer. Each MSISDN in the range may be dynamically associated with an ACID when a quality on demand (QoD) session is created for the corresponding application (e.g., the application API is called). The MSISDN may be de-associated from the ACID when the QoD session is removed for the corresponding application. In implementations, each MSISDN in the range may correspond to an individual billing account number of the customer.

The authentication module 608 may be configured to authenticate an application ID and an associated device ID are authorized to use the service subscribed by the customer. The authentication module 608 may look up the associated database and determine whether the application ID and the associated device ID present in the database.

The charging data generating module 610 may be configured to generate the charging data to bill the customer in the corresponding channel of the wireless service provider’s billing system. In some examples, the charging data generating module 610 may generate a charging data record (CDR) for a requested session duration once a QoD session is successfully created. In some examples, the charging data generating module 610 may calculate the session duration based on a start time and a stop time of the QoD session and generate the CDR based on the calculated session duration. In implementations, the charging data generating module 610 may generate the CDR based on the number of API calls from the customer’s properties, e.g., rental car computing systems, gaming devices, drones, etc.

The communication interface(s) 616 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 616 can be compatible with multiple radio access technologies, such as 5G radio access technologies and 4G/LTE radio access technologies. Accordingly, the communication interfaces 616 can allow the computing device 600 to connect to the 5G system described herein.

Display 612 can be a liquid crystal display or any other type of display commonly used in the computing device 600. For example, display 612 may be a touch-sensitive display screen and can then also act as an input device or keypad, such as for providing a soft-key keyboard, navigation buttons, or any other type of input. Input/output device(s) 614 can include any sort of output devices known in the art, such as display 612, speakers, a vibrating mechanism, and/or a tactile feedback mechanism. Input/output device(s) 614 can also include ports for one or more peripheral devices, such as headphones, peripheral speakers, and/or a peripheral display. Input/output device(s) 614 can include any sort of input devices known in the art. For example, input/output device(s) 614 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, which embodies any one or more of the methodologies or functions described herein. The instructions can also reside, completely or at least partially, within the memory 604, processor(s) 602, and/or communication interface(s) 616 during execution thereof by the computing device 600. The memory 604 and the processor(s) 602 also can constitute machine readable media 518.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computing device, comprising:
a processor;
a non-transitory computer-readable memory storing computer-executable instructions that, when executed by the processor, cause the processor to perform actions including:
receiving, from an application running on a computing device associated with a customer of a wireless service provider, a request for a network resource, the request including an application identifier (ID), a device ID, and a time period for using the network resource following an activation of the application on the computing device;
authenticating the application ID and the device ID;
upon authenticating the application ID and the device ID being successful, granting the network resource to the application for the time period; and
generating, based on granting the network resource to the application for the time period, charging data directed to the customer.

2. The computing device of claim 1, wherein
the application includes a quality on demand (QoD) application, and
the network resource includes a network slice.

3. The computing device of claim 2, wherein the computer-executable instructions, when executed by the processor, cause the processor to perform actions further including:
provision the network slice to be assigned to the QoD application.

4. The computing device of claim 3, wherein the request further includes a quality of service (QoS) profile, the computer-executable instructions, when executed by the processor, cause the processor to perform actions further including:
validating that the QoS profile is included in services subscribed by the customer;
generating a service order code (SOC) feature corresponding to the QoS profile; and
storing the QoS profile and the SOC feature in a data storage.

5. The computing device of claim 1, wherein the computer-executable instructions, when executed by the processor, cause the processor to perform actions further including:
building a data storage associated with a plurality of customers partnering with the wireless service provider, the plurality of customers including the customer;
for each customer of the plurality of customers,
creating a corresponding customer record including a corresponding device ID, a corresponding customer billing account number, a corresponding customer name, a corresponding application ID, and a corresponding charging channel.

6. The computing device of claim 5, wherein the computer-executable instructions, when executed by the processor, cause the processor to perform actions further including:
searching the data storage for a match between the application ID and the device ID and data of a customer record in the customer records; and
based on the match between the application ID and the device ID and the data of a customer record in the customer records being present, determining that the application ID and the device ID are authenticated.

7. The computing device of claim 1, wherein the computer-executable instructions, when executed by the processor, cause the processor to perform actions further including:
receiving, from the application, a second request to remove the network resource;
determining that a duration of using the network resource is less the time period;
issuing a refund corresponding to remaining duration to the customer.

8. A computing device, comprising:
a processor;
a non-transitory computer-readable memory storing computer-executable instructions that, when executed by the processor, cause the processor to perform actions including:
receiving, from an application running on the computing device associated with a customer of wireless service provider, a request for a network resource, the request including an application identifier (ID) and a device ID; authenticating the application ID and the device ID;
upon authenticating the application ID and the device ID being successful, granting the network resource to the application;
determining a duration of using the network resource; and
generating, based at least in part on the duration of using the network resource, charging data directed to the customer.

9. The computing device of claim 8, wherein the computer-executable instructions, when executed by the processor, cause the processor to perform actions further including:
determining, based on granting the network resource to the application, a start time of using the network resource;
receiving, from the application, a second request to remove the network resource;
determining, based at least in on the second request, a stop time of using the network resource; and
determining, base at least in part on the start time and the stop time, the duration of using the network slice.

10. The computing device of claim 8, wherein
the application includes a quality on demand (QoD) application, and
the network resource includes a network slice.

11. The computing device of claim 10, wherein the computer-executable instructions, when executed by the processor, cause the processor to perform actions further including:
provision the network slice to be assigned to the QoD application.

12. The computing device of claim 11, wherein the request further includes a quality of service (QoS) profile, the computer-executable instructions, when executed by the processor, cause the processor to perform actions further including:
validating that the QoS profile is included in services subscribed by the customer;
generating a service order code (SOC) feature corresponding to the QoS profile; and
storing the QoS profile and the SOC feature in a data storage.

13. The computing device of claim 8, wherein the computer-executable instructions, when executed by the processor, cause the processor to perform actions further including:
building a data storage associated with a plurality of customers partnering with the wireless service provider, the plurality of customers including the customer;
for each customer of the plurality of customers,
creating a corresponding customer record including a corresponding device ID, a corresponding customer billing account number, a corresponding customer name, a corresponding application ID, and a corresponding charging channel.

14. The computing device of claim 13, wherein the computer-executable instructions, when executed by the processor, cause the processor to perform actions further including:
searching the data storage for a match between the application ID and the device ID and data of a customer record in the customer records; and
based on the match between the application ID and the device ID and the data of a customer record in the customer records being present, determining that the application ID and the device ID are authenticated.

15. A computer-readable storage medium storing computer-readable instructions, that when executed by a processor, cause the processor to perform operations comprising:
receiving, from an application running on a computing device associated with a customer of a wireless service provider, a request for a network resource, the request including an application identifier (ID), a device ID, and a time period for using the network resource;
authenticating the application ID and the device ID;
upon authenticating the application ID and the device ID being successful, granting the network resource to the application for the time period; and
generating, based on granting the network resource to the application for the time period, charging data directed to the customer.

16. The computer-readable storage medium of claim 15, wherein
the application includes a quality on demand (QoD) application, and
the network resource includes a network slice.

17. The computer-readable storage medium of claim 16, wherein the request further includes a quality of service (QoS) profile, the computer-readable instructions, when executed by the processor, cause the processor to perform actions further including:
validating that the QoS profile is included in services subscribed by the customer;
generating a service order code (SOC) feature corresponding to the QoS profile; and
storing the QoS profile and the SOC feature in a data storage.

18. The computer-readable storage medium of claim 15, wherein the computer-readable instructions, when executed by the processor, cause the processor to perform actions further including:
building a data storage associated with a plurality of customers partnering with the wireless service provider, the plurality of customers including the customer;
for each customer of the plurality of customers,
creating a corresponding customer record including a corresponding device ID, a corresponding customer billing account number, a corresponding customer name, a corresponding application ID, and a corresponding charging channel.

19. The computer-readable storage medium of claim 18, wherein the computer-readable instructions, when executed by the processor, cause the processor to perform actions further including:
searching the data storage for a match between the application ID and the device ID and data of a customer record in the customer records; and
based on the match between the application ID and the device ID and the data of a customer record in the customer records being present, determining that the application ID and the device ID are authenticated.

20. The computer-readable storage medium of claim 15, wherein the computer-readable instructions, when executed by the processor, cause the processor to perform actions further including:
receiving, from the application, a second request to remove the network resource;
determining that a duration of using the network slice is less the time period;
issuing a refund corresponding to remaining duration to the customer.
